(19) United States
(12) Patent Application Publication
(10) Pub. No.: US 2001/0044931 A1
(43) Pub. Date: Nov. 22, 2001

(54) Compile method suitable for speculation mechanism

(76) Inventors: Ichiro Kyushima, Yokohama (JP); Hiroyasu Nishiyama, Kawasaki (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/854,458

(22) Filed: May 15, 2001

(30) Foreign Application Priority Data
May 16, 2000 (JP) 2000-148588

(51) Int. Cl. G06F 9/45

(52) U.S. Cl. 717/9; 717/7

(57) ABSTRACT

Based on a repetitively executed program fragment like a loop in a source program, at least two patterns of object codes are generated which include object codes (a) using a speculative instruction and a speculative check instruction and an object codes (b) not using the speculative instruction and the speculative check instruction. Other object codes are generated that perform control transfer so that after the number of times a speculation failure is detected by the speculation check during the execution of the codes (a) satisfies a predetermined condition, the codes (b) are used for the subsequent repetitive execution.

### BACKGROUND OF THE INVENTION

The present invention relates to a compile method capable of reducing an execution time of an object program in a computer application technology and more specifically to a compile method suitable for computers with a speculation mechanism.

To execute an object program at high speed, some microprocessors in recent years have a speculative instruction (speculative load instruction) to speculatively execute a particular instruction (mainly load instruction) and a check instruction (speculative check instruction) to see if the speculative execution is a failure. These instructions combined are called a speculation mechanism. The speculation mechanism and a program optimization method using it are described, for example, in Intel: “IA-64 Application Developer's Architecture Guide,” May 1999, Order Number: 245188-001, Section 10-4 and 10-5.

One example of program optimization using the speculation mechanism is a loop invariant code motion with an uncertain dependence. This is explained by referring to a program fragment 200 in FIG. 2. The program fragment 200 in FIG. 2 is described in the programming language C and represents a loop that repetitively executes statements (202) to (204) while the condition of (201) cond is satisfied. The statement (202) calculates a+b and assigns the result to c. The statement (203) writes the value of c into a memory (*p) pointed to by an address represented by p. (204) updates the value of p.

If object codes are generated from the program fragment 200 without using the speculation mechanism, the result is as shown at 300 in FIG. 3. To make the codes in FIG. 3 easily understood, it is described partly in the syntax of the programming language C. In FIG. 3, while the condition cond of (301) is satisfied, the instructions (302)-(306) are executed repetitively. (302) loads a memory content indicated by an address (&a) of variable a, i.e., the value of a, into a register r1. (303) similarly loads the value of b from memory into a register r2. (304) calculates the sum of r1 and r2 and assigns the result into r3. (305) stores the value of r3 into a memory location pointed to by an address represented by p. (306) updates the value of p.

Because it is highly probable that the codes 300 of FIG. 3 calculate the same value every time by repetitively executing the loop, that is, because it is highly probable that the codes are loop invariant, the execution time is shortened by moving these instructions out of the loop (computation is done only once before entering the loop and, in the loop, the calculated value is used). However, such code motion cannot be made when the address represented by p and the address represented by a or b coincide with each other. That is, when a memory address as the destination of a store instruction of (305) coincides with a memory address as the load source of (302) or (303), because the value of a or b is written over by the writing into *p, the values calculated by (302) to (304) are not loop invariant and thus the instructions of (302) to (304) cannot be moved out of the loop. When there is an uncertain dependence (when it is not known whether a memory address as a store destination of one step and a memory address as a load source of another step match), the compiler cannot generally execute the loop invariant code motion.

When a speculation mechanism is used, the loop invariant code motion can be performed on the program fragment of FIG. 2. The object codes obtained are shown at 400 in FIG. 4. In FIG. 4, the loading of a, the loading of b and the summing of a and b are moved out of the loop ((401)-(403) enclosed by dashed line). The load instructions outside the loop are not normal load instructions but speculative ones and so use ld.a instructions (“a” represents “advanced”). In the loop, placed at (405) and (406) are check instructions (chk.a) to check whether the speculative loads are valid instead of the load instructions.

For example, chk.a r1, recover1 at (405) checks if the memory address from which its content was read by the load ld.a instruction was written into by any store instruction during the period from the ld.a instruction on the register r1 to the present chk.a instruction. If that memory address is found to have been written by a store instruction, the speculative execution is decided as a failure and the check instruction branches to a recover1 (410), where the value of a is re-loaded at (411), a+b is calculated at (412) and the control is returned at (413) to an instruction (406) immediately following the check instruction. The check instruction at (406) and its branch codes of recover2 at (414)-(417) are similarly executed. The codes (410)-(413) and the codes (414)-(417) are a called recovery codes because the load instructions are re-executed when they are trapped by the speculation check instructions (i.e., when the speculation fails).

In the codes 400 shown in FIG. 4, because the load and add instructions are not executed in the loop unless the speculative check branches to the recovery codes, these codes are expected to have a shorter execution time than that for the codes of FIG. 3 (Although the codes in the loop of FIG. 4 is only one instruction less than that of FIG. 3, it is expected to provide more of an advantage than can the reduced number of instructions because a check instruction can generally be executed in a smaller number of cycles than the load and add instructions).

With the speculation mechanism, therefore, even when there is uncertain dependence between the load and store instructions, the loop invariant code motion can be achieved. In addition to the loop invariant code motion, other instruction scheduling can also be used when there is uncertain dependence between the load and store instructions, as by moving the load instruction to a position where it is executed before the store instruction.

### SUMMARY OF THE INVENTION

In the conventional technique, however, when the speculative check branches to recovery codes frequently, the execution speed may be reduced. In the codes 400 of FIG. 4, for example, when the chk.a instruction at (405) or (406) branches to recovery codes frequently, the overhead due to branching and recalculation will likely degrade the performance.

It is therefore an object of the present invention to provide a compile method and a compiler which can reduce an execution time of object codes using the speculation mechanism. More specifically, in a compiler that generates codes using the speculation mechanism, it is an object to provide a compile method capable of generating object codes in which a program fragment, such as the instruction sequence (404)-(409) of FIG. 4, that is executed repetitively during the execution of the object codes does not get trapped frequently by the speculation check to branch to recovery codes thereby degrading the performance of the codes.

To achieve the above objective, the compile method of this invention performs the following.

(1) Based on a repetitively executed source code portion like a loop, the compiler generates two patterns of codes: codes (a) using the speculation mechanism (speculative instructions and speculative check instructions) and codes (b) not using the speculation mechanism. At first, the codes (a) using the speculation mechanism is executed.

(2) In recovery codes, which are executed when a speculation failure is detected by the speculative check instruction in the code pattern (a) using the speculation mechanism, the number of speculation failures is counted. Once the counter exceeds an upper limit, the code pattern (b) not using the speculation mechanism is executed.

Thus, after the number of times the speculation failure is detected by the speculation check exceeds a predetermined value, the codes (b) not using the speculation mechanism are executed. This prevents a possible performance degradation which would otherwise be caused by the frequent branching to recovery codes in the event of the speculation failure detected by the speculation check. When the number of speculation failures detected by the speculation check is small, the codes (a) using the speculation mechanism are executed, so that the execution speed is faster than when the speculation mechanism is not used. If the upper limit of the number of speculation failures is set to 1, there is no need to count the number of speculation failures. It is possible to use, rather than the number of speculation failures, a rate represented by the ratio of the number of speculation failures to the number of executions of the loop.

### BRIEF DESCRIPTION OF THE DRAWINGS

FIG. 1 is a configuration of a computer system on which the compiler of this invention is run.

FIG. 2 is an example source program.

FIG. 3 is codes generated by a conventional technique not using the speculation mechanism.

FIG. 4 is codes generated by a conventional technique using the speculation mechanism.

FIG. 5 is a flow chart showing a flow of the compile processing.

FIG. 6 is a diagram showing an example of intermediate codes for the source program of FIG. 2.

FIG. 7 is a flow chart showing a flow of a loop invariant code motion processing applying this invention.

FIG. 8 is a diagram showing an example of intermediate codes immediately after the duplication of loop.

FIG. 9 is a diagram showing an example of intermediate codes immediately after an initial load instruction has been moved out of the loop.

FIG. 10 is a diagram showing an example of intermediate codes after the loop invariant code motion.

FIG. 11 is an example of codes generated by applying this invention.

FIG. 12 is another example of codes generated by applying this invention.

FIG. 13 is still another example of codes generated by applying this invention.

### DESCRIPTION OF THE EMBODIMENTS

Now, a compiler that performs the loop invariant code motion using the speculation mechanism will be described as one embodiment of this invention.

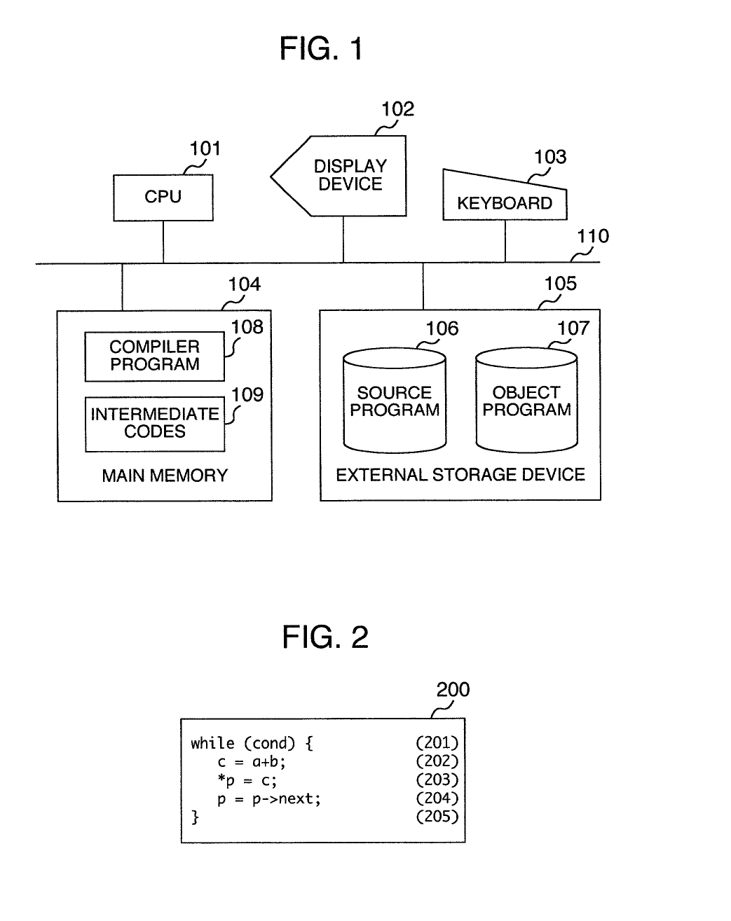

FIG. 1 shows a system configuration of a computer system on which to run the compiler. As shown in the figure, the computer system includes a CPU 101, a main memory 104, an external storage device 105, a display device 102 and a keyboard 103, connected to a bus 110. The external storage device 105 stores a source program 106 and an object program 107 generated by compiling the source program 106. In the main memory 104 are held a compiler program 108 and intermediate codes 109 required by the compile processing. The compile processing is performed by the CPU 101 executing the compiler program 108. The keyboard 103 is used to issue a command from the user to the compiler program 108. The display device 102 informs the end of the compile processing or errors to the user.

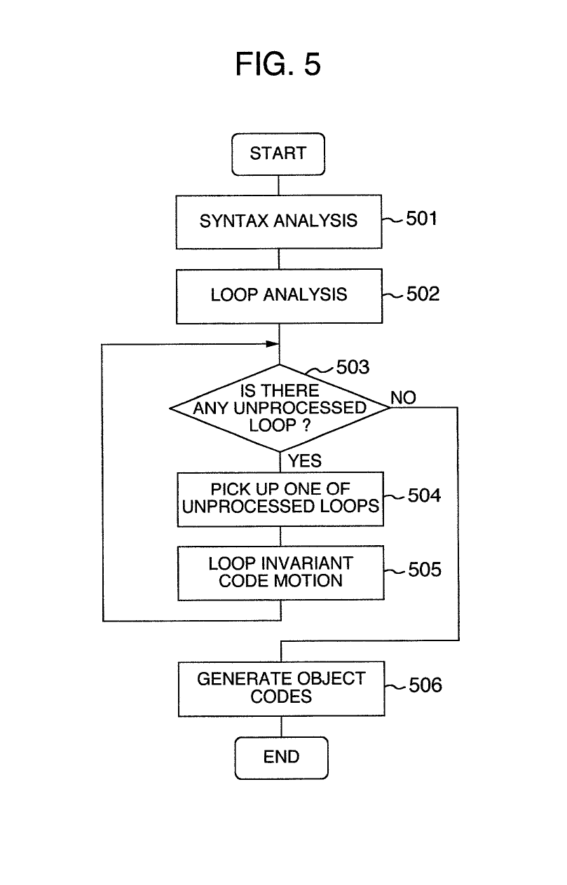

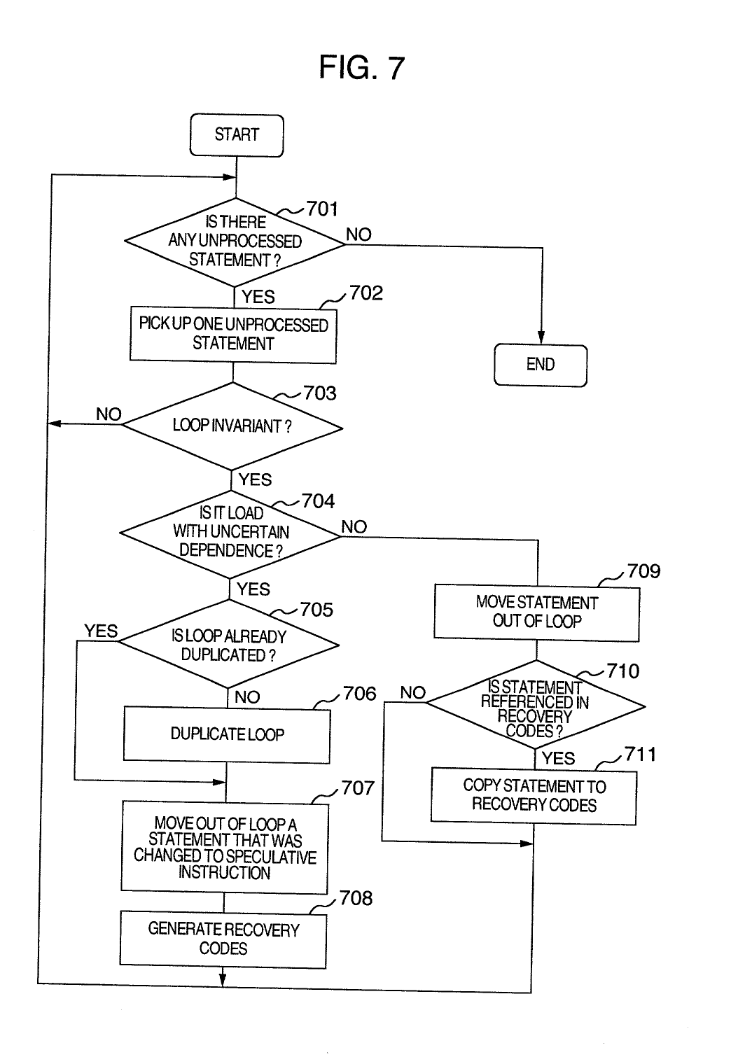

FIG. 5 is a flow chart showing a flow of the compile processing. The compiler first performs a syntax analysis in step 501. The syntax analysis involves reading the source program 106 and generating the intermediate codes 109 that can be processed in the compiler. The detail of the syntax analysis is found in Aho, Sethi, Ullman, “Compilers, Principles, Techniques, and Tools”, Addison-Wesley, March 1986, pp. 25-62 and is not explained here. Next, in step 502, the loop analysis is performed. Aho, Sethi, Ullman, “Compilers, Principles, Techniques, and Tools”, Addison-Wesley, March 1986, pp. 602-604 also describes the loop analysis and its detail is not presented here. The loop analysis determines a set of loops included in the program. Next, step 503 checks to see if there is any loop not yet processed. If not, the processing moves to step 506 where it generates an object codes before terminating the compile program. The generation of object codes is described also in Aho, Sethi, Ullman, “Compilers, Principles, Techniques, and Tools”, Addison-Wesley, March 1986, pp. 514-580 and its detailed explanation is not presented here. If there is any loop not yet processed, step 504 picks up one of the loops. Step 505 performs the loop invariant code motion using the speculation mechanism. The processing performed by step 505 will be described by referring to FIG. 7. After this, the processing is repeated from step 503.

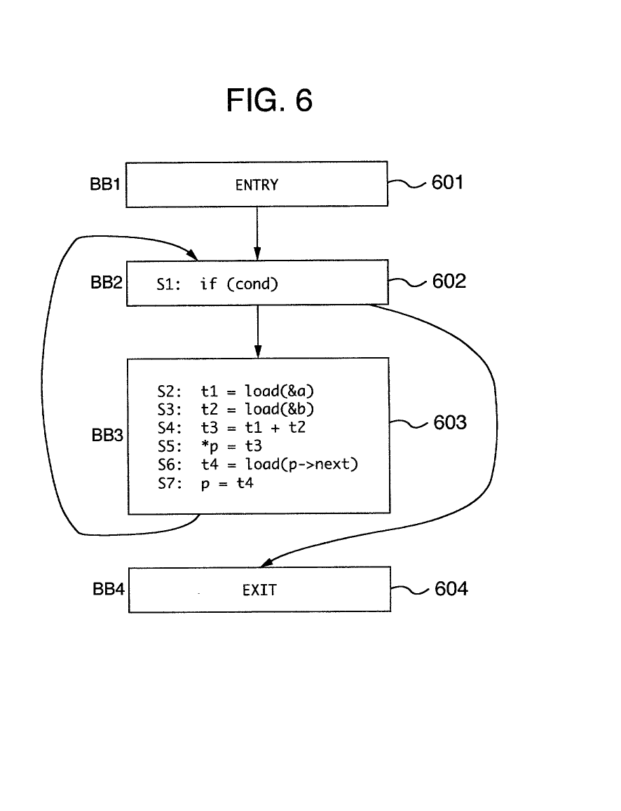

FIG. 6 is an example of intermediate codes for the compiler in this embodiment. The intermediate codes are generated by the syntax analysis 501. The intermediate codes of FIG. 6 correspond to the source program of FIG. 2. The intermediate codes of FIG. 6 are represented by a diagram in which basic blocks (abbreviated BB) are connected with edges (or arrows) (this diagram is called a control flow graph). Denoted 601 to 604 are basic blocks. These basic blocks are assigned numbers BB1 to BB4. Each basic block represents a code sequence without a branch or jump on the way. The edge (arrow) indicates a transfer from one basic block to another. For example, an edge running from a basic block 601 to a basic block 602 indicates that the control is transferred from 601 to 602 when the basic block 601 is finished. The methods of analyzing the basic blocks and of constructing the control flow graph are described in the preceding literature “Compilers, Principles, Techniques, and Tools”, pp. 528-534, and they are not explained here. What is written in each basic block is execution statements that are executed when the control is transferred to the associated basic block. Shown to the left of each of the statements (S1-S7) is a statement number.

FIG. 7 is a flow chart showing the detail of a process flow in the loop invariant code motion processing 505 using the speculation mechanism. First, step 701 checks if there is any statement (instruction) in the loop that is not yet processed. If not, the processing ends. If any statement that needs to be processed exists, the processing moves to step 702 where it picks up one of the unprocessed statements. Step 703 checks if the statement picked up is a loop invariant code. Whether it is a loop invariant code is determined by checking if all operands are loop-invariant. In the case of a load instruction, a check is made as to whether the memory address from which the memory content is to be loaded is loop-invariant. It should be noted, however, that when there is apparent dependence in the loop (the same address is used for a store instruction), the statement is determined to be not loop-invariant even if the address is loop-invariant. (When there is uncertain dependence, the statement is regarded as a loop invariant code.) If the statement is not a loop variant code, the processing loops back to step 701.

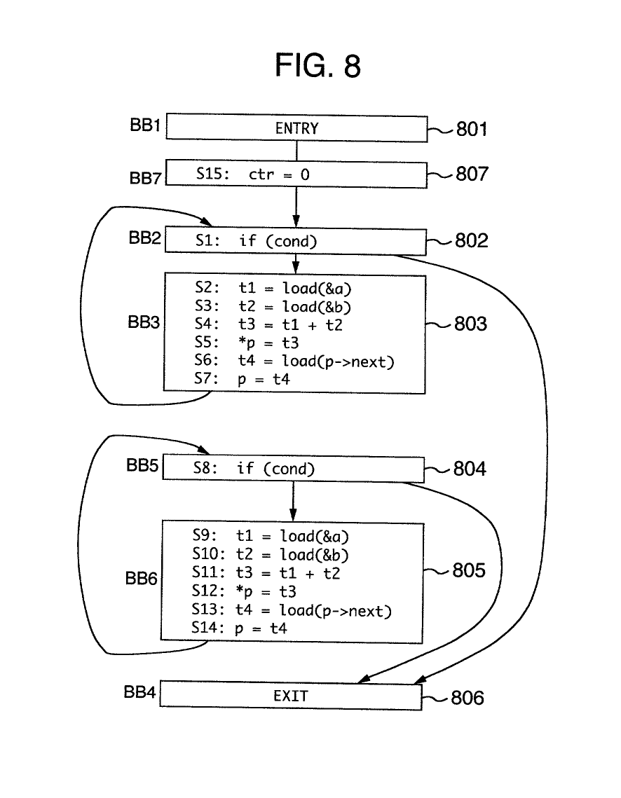

If the statement is found loop-invariant, it is checked whether the statement is a load instruction and there is uncertain dependence (a possibility that a store instruction to the memory address from which the memory content is to be loaded may be executed in the loop). If so, the processing moves to step 705. Step 705 checks if the loop has already been duplicated (or copied). When the duplication of the loop is not yet made, the processing proceeds to step 706 where it duplicates the loop. This generates a copied loop at a position following the original loop. For example, the intermediate codes of FIG. 6 will be as shown in FIG. 8 after the step 706 is performed. In FIG. 8, BB5 (804) and BB6 (805) form the duplicated loop. Further, before the original loop a code (S15 in 807) for clearing the counter to zero is inserted.

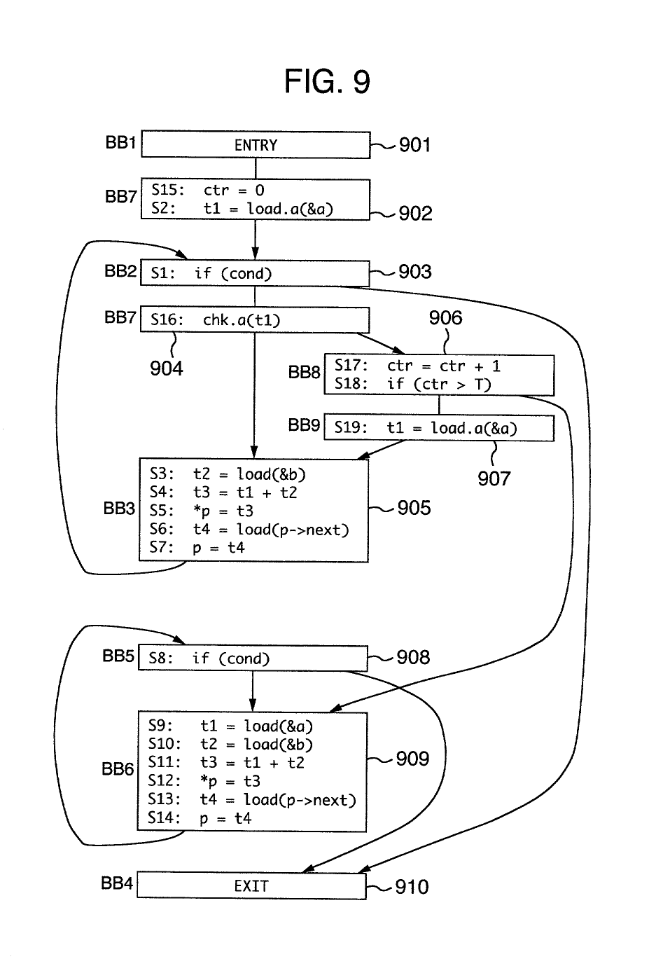

Next, step 707 moves the load instruction in question out of the loop. At that time, the load instruction is changed to a speculative load instruction (load.a). Next, step 708 places a check instruction (chk.a) where the original load instruction was located and also generates recovery coded that are branched to by the speculation check in the event of a speculation failure. This is shown in FIG. 9.

FIG. 9 shows that a branch from the check instruction (S16 in 904) to the recovery codes (906) is generated. At the start of the recovery codes, there is an instruction for incrementing the counter (S17 in 906) and an instruction for branching to the duplicated loop when the counter exceeds a predetermined value (S18 in 906). When the counter does not exceed the predetermined value, a is reloaded (S19 in 907) and the control returns to the instruction (S3 in 905) following the check instruction.

Returning to FIG. 7, when step 705 finds that the loop is already duplicated, the processing moves to step 707. In the case of the intermediate codes in FIG. 8, the moving of the first load instruction (S2) is accompanied by the duplication of the loop but the moving of the second load instruction (S3) skips the loop duplication.

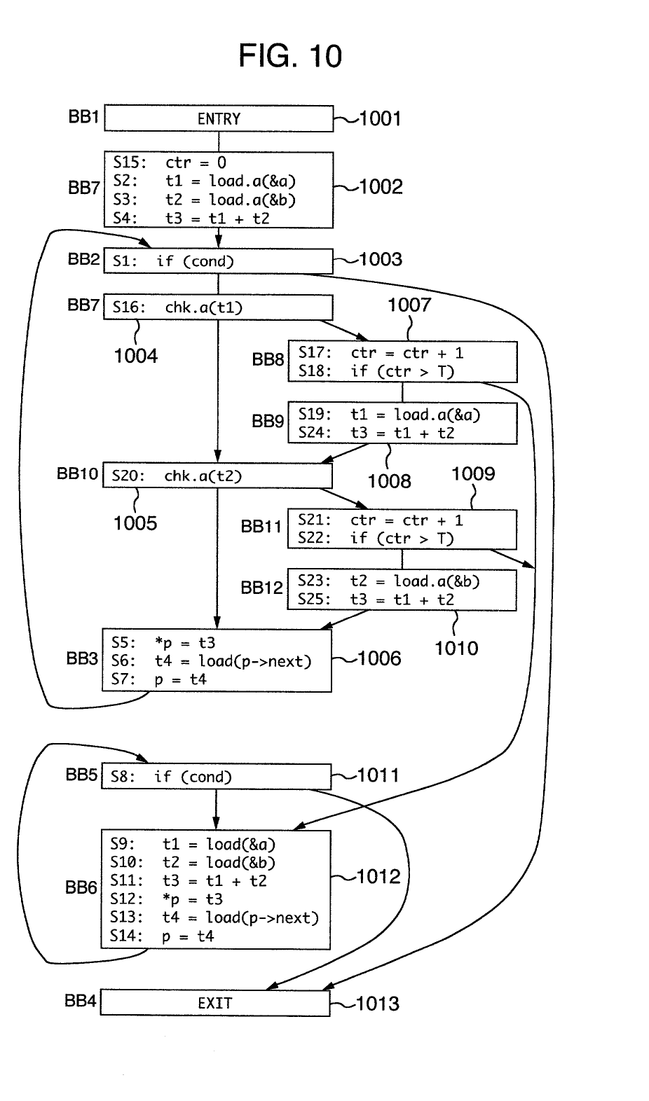

Step 709 moves the statement in question out of the loop, as in the conventional loop invariant code motion. Further, step 710 checks if an operand referenced by the statement moved out of the loop is defined in the recovery codes. If so, step 711 copies the instruction also to a position in the recovery code immediately following the operand defining statement. For example, when the statement (t3=t1+t2) S4 in 905 is moved out of the loop by the step 709, because its operand t1, t2 is defined in S19 (t1=load.a(&a)), that instruction is also copied to a position immediately after the operand defining statement. With the processing executed as shown in FIG. 7 the intermediate codes of FIG. 8 eventually become as shown in FIG. 10.

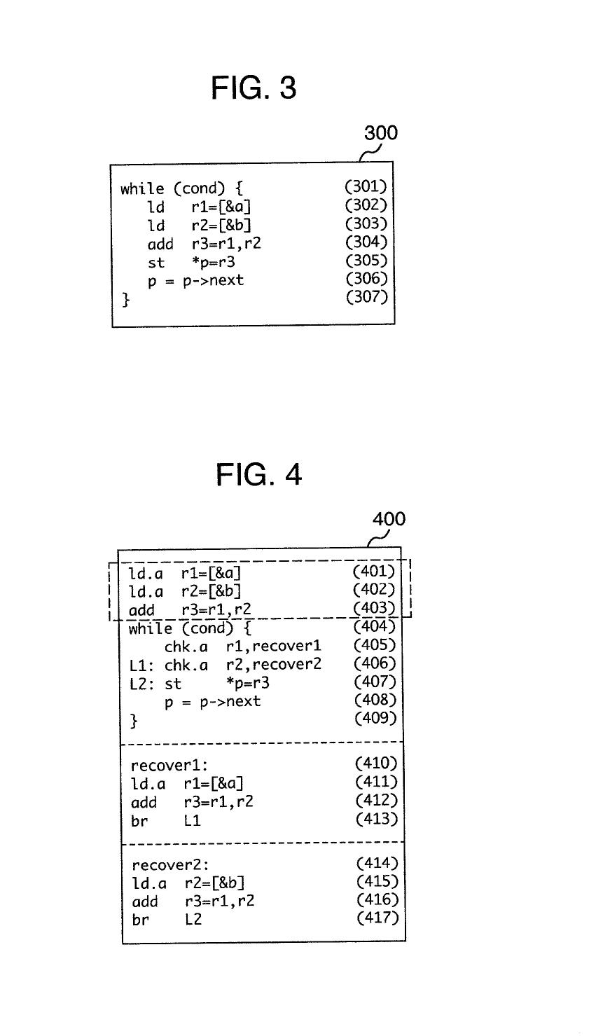

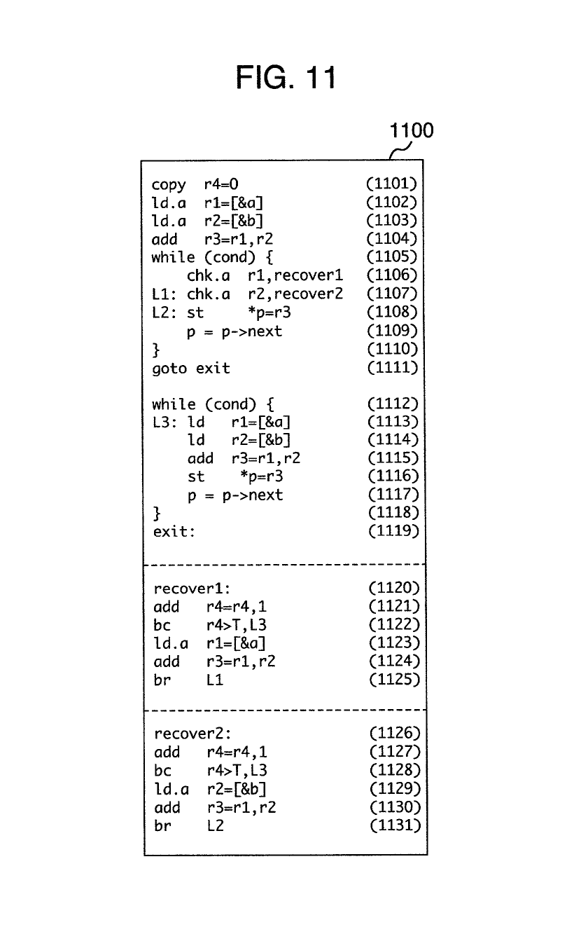

FIG. 11 shows object codes compiled from the intermediate codes of FIG. 10 by the compiler of this invention. For ease of understanding, the codes are described partly in the syntax of the programming language C as in FIGS. 2 and 3. In the program 1100 of FIG. 11, there are two loops, one using the speculation mechanism to perform a loop variant code motion and one not using the speculation mechanism. The first loop is executed by using the speculation mechanism. In the recovery codes (1120-1125) branched to by the first check instruction (1106) in the loop using the speculation mechanism in the event of a speculation failure, the counter is first incremented or updated (1121). When the counter exceeds a predetermined value, the control is transferred to the loop that does not use the speculation mechanism (1122). The same is true for the second check instruction (1107). With this arrangement, when the speculation failure occurs frequently, the loop not using the speculation mechanism is executed, thus preventing the execution speed from deteriorating due to the process of recovery from the speculation failure. When the speculation failure occurs less frequently, the codes using the speculation mechanism (and moved by the loop invariant code motion) are executed, resulting in a faster execution speed than when the speculation mechanism is not used.

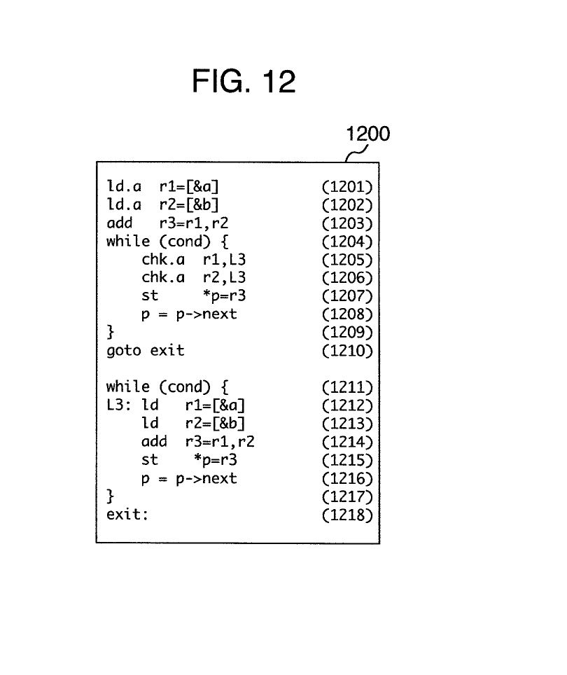

In the embodiments above, the number of times that the speculation failure occurs is counted by using a counter. When the upper limit to the number of speculation failures is set to 1, the incrementing of the counter is not required. That is, a single speculation failure results in the control directly branching to the codes not using the speculation mechanism. That is, step 708 transfers the control from the check instruction directly to the duplicated loop without generating recovery codes. The object codes generated in this case are as shown in FIG. 12.

A program 1200 of FIG. 12 has two loops, one (1204-1209) using the speculation mechanism to effect the loop invariant code motion and the other (1211-1217) not using the speculation mechanism. When a speculation failure is detected by the check instructions (1205, 1206) in the loop using the speculation mechanism, the control directly branches to the loop not using the speculation mechanism. This offers an advantage of obviating the steps in the recovery codes that would otherwise be required for incrementing the counter and comparing the counter value.

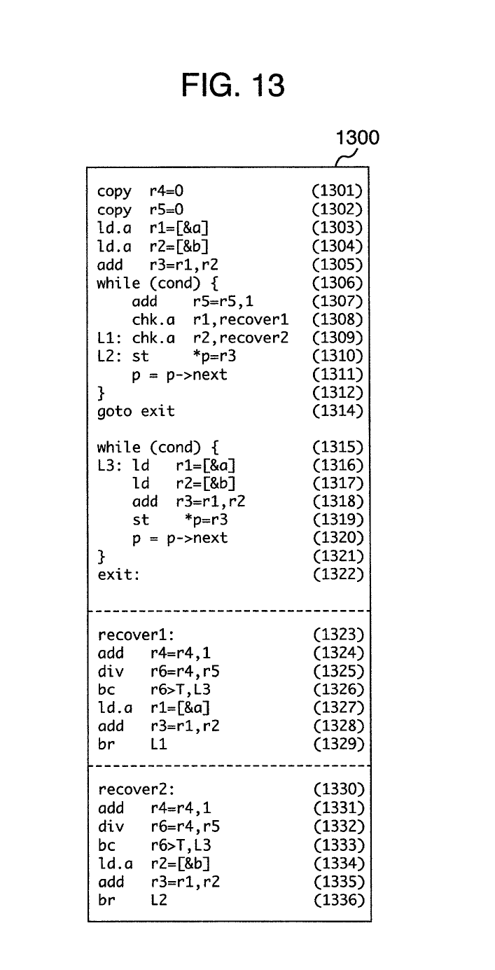

While in the embodiments above the number of speculation failures is taken as a threshold value, it is possible to take a probability (rate) of speculation failure as the threshold. That is, a check is made as to whether M/N is in excess of a predetermined value, where N is the number of times the loop has been executed and M is the number times the speculation failure has occurred. The object codes thus generated are shown in FIG. 13. The program 1300 in FIG. 13 has two loops, one (1306-1312) using the speculation mechanism to effect the loop invariant code motion and the other (1315-1321) not using the speculation mechanism. In the loop using the speculation mechanism, the number of times the loop is executed is counted (1307). In the recovery codes (1323-1329) branched to by the first check instruction (1308) in the loop using the speculation mechanism in the event of a speculation failure, the counter indicating the number of speculation failures is incremented (1324) and divided by the number of loop executions (1325). When the divided value exceeds a predetermined value, the control returns to the loop not using the speculation mechanism (1326). The same applies also to the second check instruction (1309). Although this arrangement causes additional overhead by counting the number of loop executions and by division calculation, it provides an advantage of being able to use the probability of speculation failure in deciding which of the loops should be executed and therefore to make this decision more precisely.

While the above embodiments apply the present invention to use the speculation mechanism in realizing the loop variant code motion, this invention is not limited to these embodiments but can also be applied to cases where instructions are moved within a loop (instruction scheduling) by using the speculation mechanism. The instruction scheduling is an optimization that rearranges the order of instructions to hide instruction latency and reduce the execution time of the instruction sequence. When there is an uncertain dependence between a store instruction and a subsequent load instruction (i.e., there is a possibility of a match between the memory addresses referenced by the two instructions), the load instruction generally cannot be moved in front of the store instruction. But the use of the speculation mechanism allows the instructions to be rearranged in the order. That is, it is possible to execute the speculative load instruction before the store instruction and then, after the store instruction, execute a check instruction. When this invention is used for the instruction scheduling that applies the speculation mechanism to a loop, the necessary steps involve generating two loop codes, one using the speculation mechanism and the other not using it, and then, when the number of speculation failures detected by the check instruction in a loop using the speculation mechanism satisfies a certain condition, branching to the other loop not using the speculation mechanism. This can prevent a possible performance deterioration which may be caused by frequent speculation failures detected by the speculation check.

1. A compile method in a compiler suitable for a speculation mechanism, wherein said compiler generates object codes for a processor having a speculative instruction and a speculative check instruction for checking a speculation failure (said speculative instruction and speculative check instruction are generally called a “speculation mechanism”), said compile method comprising the steps of:
(a) generating first object codes using said speculation mechanism from a repetitively executed fragment of a source program;
(b) generating second object codes not using said speculation mechanism from said repetitively executed fragment of said source program; and
(c) generating third object codes that perform a control transfer so that after a number of times a speculation failure is detected by said speculative check instruction during execution of said first object codes satisfies a predetermined condition, said second object codes for said repetitively executed program fragment are executed.

2. A compile method suitable for a speculation mechanism according to claim 1, wherein said predetermined condition in said step (c) is that the number of times a speculation failure is detected exceeds a predetermined value.

3. A compile method suitable for a speculation mechanism according to claim 1, wherein said predetermined condition in said step (c) is that a ratio of the number of times a speculation failure is detected by the speculation check to a number of times the repetitively executed program fragment is executed exceeds a predetermined value.

4. A compile method suitable for a speculation mechanism according to claim 1, wherein when a speculation failure is detected by the speculation check, a value of counter is incremented and when the counter value exceeds a predetermined value, said third object codes transfer control to execution of said second object codes.

5. A compile method suitable for a speculation mechanism according to claim 1, wherein once said speculation failure is detected, said third object codes transfer control to execution of said second object codes.

6. A compiler program using said compile method according to claim 1.

7. A storage medium storing the compiler program according to claim 6.

8. A compile method for generating an object program from a source program including repetitive loop processing, said compile method comprising the steps of:
generating first object codes from said source program by using a speculative instruction and a speculative check instruction for checking a speculation failure;
generating second object codes from said source program without using said speculative instruction and said speculative check instruction;
generating third object codes that perform control to first execute said first object codes;
generating fourth object codes to count a number a times the speculation failure occurs during execution of said first object codes; and
generating fifth object codes that perform control to execute said second object codes after the number of times reaches a predetermined value.

9. A computer for generating an object program from a source program including repetitive loop processing, comprising:
a memory device to store said source program;
a central processing unit (CPU) to execute a compiler program for generating said object program from said source program;
a display device to output a result of compile processing executed by said CPU; and
a bus to connect said memory device, said CPU and said display device;
wherein said CPU generates said object program by executing a compiler program that includes the steps of:
generating first object codes from said source program by using a speculative instruction and a speculative check instruction for checking a speculation failure;
generating second object codes from said source program without using said speculative instruction and said speculative check instruction;
generating third object codes that perform control to first execute said first object codes;
generating fourth object codes to count a number of times a speculation failure occurs during execution of said first object codes; and
generating fifth object codes that perform control to execute said second object codes after the number of times reaches a predetermined value.

10. An object program generated from a source program including repetitive loop processing including:
a first object code portion generated from said source program by using a speculative instruction and a speculative check instruction for checking a speculation failure;
a second object code portion generated from said source program without using said speculative instruction and said speculative check instruction;
a third object code portion that performs control to first execute said first object code portion;
a fourth object code portion to count a number of times a speculation failure occurs during execution of said first object code portion; and
a fifth object code portion that performs control to execute said second object code portion after the number of times reaches a predetermined value.

11. A storage medium storing the object program according to claim 10.
